(19) United States
(12) Patent Application Publication
(10) Pub. No.: US 2014/0083059 A1
(43) Pub. Date: Mar. 27, 2014

(54) METHOD AND DEVICE FOR TRANSPORTING CONTAINERS FILLED WITH FLUID

(71) Applicant: Krones AG, Neutraubling (DE)

(72) Inventor: RUPERT MEINZINGER, Neutraubling (DE)

(73) Assignee: Krones AG, Neutraubling (DE)

(21) Appl. No.: 14/032,974

(22) Filed: Sep. 20, 2013

(30) Foreign Application Priority Data
Sep. 21, 2012 (DE) 102012108928.0

(51) Int. Cl. B65G 19/02; B65B 7/16

(52) U.S. Cl. CPC B65G 19/02; B65B 7/16
USPC 53/484; 198/339.1

(57) ABSTRACT

Methods for transporting containers filled with fluid, preferably for transporting containers filled with fluid which have a flexible base, comprising lowering the fluid level of the fluid in the filled container, and transporting the container with a lowered fluid level and systems thereof.

### CROSS REFERENCE TO RELATED APPLICATION

This application claims priority from German Patent Application No. 10 2012 108 928.0 filed on Sep. 21, 2012 in the German Patent and Trademark Office, the disclosure of which is incorporated herein by reference in its entirety.

### BACKGROUND

1. Technical Field

The present invention relates to a method and a device for transporting containers filled with a fluid, preferably for transporting beverage containers filled with a beverage.

2. Related Art

It is known to transport containers filled with a fluid, for example filled beverage containers, via transport starwheels, rotary machines, conveyor belts, retaining clamps or other conveying devices between the various treatment stations in a beverage filling plant. It is known in this context to transport the filled containers from the applicable filling station to a capper, so that the filled containers can be closed with a closure, for example a screw cap, a crown cap, a sealing lid or a roll-on cap.

When containers are transported in a beverage filling machine, and particularly when filled containers are transported, it may occur that a beverage in a container, or the fluid in the container, sloshes out as it is transported onwards, or when the direction of transport changes, and thereby contaminates the outside of the mouth of the container and the outside of the container itself.

Particularly in the case of large, non-rigid containers, such as for example large-volume PET containers with relatively large mouth apertures, which are used, for example, for filling with milk, the problem thus arises of preventing contamination of the outside of the mouth area and the outside of the container itself. This is because residues of the product in the mouth area can lead to germ formation between the mouth area of the container and the screwed-on cap. It is, however, difficult to clean the applicable mouth area, since when the mouth area is rinsed, the rinsing medium can also be introduced into the container, which is undesirable.

This problem of a filling product sloshing out of a filled container is particularly noticeable for example in the case of one-gallon containers for milk or juices. These containers are very non-rigid and at the same time filled with the applicable product to a very high fluid level, or a very high fill level.

In order to prevent the filling product from sloshing over or out of such containers, it is known from the prior art to seal the applicable mouth with the corresponding filling valve, and to remove by suction any foam that may form during filling, in order to achieve a clean outcome of the filling process.

From U.S. Pat. No. 3,945,174, for example, a method is known for capping flexible plastic containers to be filled with milk, wherein the containers usually contain a half-gallon or a full gallon of milk. In order to provide the containers with visually uniform fill levels independently of the degree to which each container shrinks and of the tolerances of the containers, the teaching proposes compressing one side wall of the container so that the fluid is maintained at a uniform level.

### SUMMARY

A method and a device is provided for transporting containers filled with fluid, by means of which the outcome of the filling process can be further improved.

In one embodiment, a method for transporting containers filled with fluid, such as for fluid-filled transporting containers which have a flexible base, comprises lowering the fluid level of the fluid in the filled container, and transporting the container with a lowered fluid level.

Because the fluid level in the filled container is initially lowered, and the container is then transported with a lowered fluid level, the tendency of the fluid held in the container to slosh out or spill during transport is significantly reduced. In this manner sloshing out or spilling of the fluid held in the container from the mouth is reduced or fully prevented, with the result that the expense of cleaning the outside of the mouth area and the external threads located on the mouth area is not necessary.

The outcome of the filling process can thereby be improved in comparison with conventional transporting devices. Furthermore, the transport can also be carried out at a higher speed than the conventional speeds, with the result that the throughput of a beverage filling plant can be increased.

In addition, lowering the fluid level during transport means that it is no longer necessary to seal the mouth area with the corresponding filling valve, with the result that free-jet fillers, which are favored for reasons of hygiene, can now be used in combination with highly flexible, large-volume beverage containers. This represents another way in which the outcome of the filling process is improved in comparison with the previously known filling methods, since in the absence of contact between the filling valve and the mouth of the container to be filled, contamination of the mouth area can be further reduced or fully prevented.

When free-jet filler valves are used, however, there is often, depending on the product, formation of foam or bubbles. Through the lowering of the fluid level of the fluid in the filled container while the container is transported, overflow of bubbles and/or foam can also be avoided, with the result that contamination of the mouth area can be reduced or fully prevented.

For further treatment of each container, the fluid level can then be raised again. Such a raising of the fluid level after the container has been transported with a lowered fluid level can be carried out, for example, in order to cap the corresponding container. In this case, the fluid level can be raised to the same fill level in every container, independently of their tolerances, so that the closed containers are all filled to an identical level within the container.

The transport of the container with a lowered fluid level, in one embodiment, comprises a change in direction and/or a transfer from a first transporting device to a second transporting device, for example from a first transport starwheel to a second transport starwheel, or from a turntable or conveyor belt to a transport starwheel. The lowering of the fluid level in the container which is filled with fluid can reduce or prevent the sloshing out of the fluid, even when the change of direction is, to a greater or lesser extent, abrupt.

Prior to the lowering of the level of the fluid in the filled container, the container, in one embodiment, is filled by a probe filler to a predetermined height. In another embodiment, prior to the lowering of the level of the fluid, or simultaneously with the lowering of the level of the fluid, the container is filled by means of a volume-controlled free-jet filler.

If the lowering of the fluid level is simultaneous with the filling of the container by means of a free-jet filler, the lowering of the fluid level can compensate for the formation of foam or bubbles, which is unavoidable with a free-jet filler.

In one embodiment, the lowering and/or raising of the fluid level is achieved by the appropriate deformation of the flexible base of a container. For example, in order to lower the fluid level, the flexible base is permitted to bulge out in the direction of gravity, i.e. downwards, which is for example achieved by the geometry of a container support being such as not to prevent the bulging out of the container or container base downwards. In other words, the corresponding container support is not flat across its entire surface, but itself has recesses, depressions or other receptacles such that the container base can bulge downwards. Thus, the applicable container support can be formed with rails or a support ring corresponding substantially to the diameter or the contours of the filled container, and for the central area to be formed at a level below that of the support surface.

In another embodiment, the container support can also be configured to be concave or formed in another polygonal, elliptical or other non-flat manner with a depression, in order to permit the base of the container to bulge downwards.

The deformation of the base of the filled container is preferably adapted to the current stage of the procedure or the current processing position within a beverage filling plant. For example at the beginning of the filling process, using for example a free-jet filler, a container support can still be formed with a completely flat surface. Then during the course of the procedure, and in particular towards the end of the filling process, the container support can permit the container base to sink downwards, for example by means of a central area of the previously completely flat container support moving to a lower position. In a later stage of processing, or at a later processing station, while the container is transported, for example, from a filling station to a capper, the fluid level is maintained in the lowered position by means of the base area remaining appropriately displaced downwards. During the transport of the container, the container can, for example, be conveyed via a ring which acts only on the edge of its base area, or via rails disposed parallel to each other, so that the base is permitted to bulge downwards and the fluid level is correspondingly lowered.

At a subsequent capping station, after transport, the fluid level is then raised again, in order to provide a uniform fill level of the closed, filled containers. The downward-bulging base area of the container can thereby be restored to its previous form such that the prevailing fill level in the mouth corresponds to a certain predetermined level. For this purpose, the appropriate restoration of the form of the base can be carried out either via a controlled form restoration means, or else by transfer from the previously not completely flat container support to a completely flat container support. Then the containers can be provided with their closures.

In a further embodiment, the base of the container, and thereby also the fluid level in the container, can be lowered by means of the lifting of the container partially or as a whole by a suitable container support. For this purpose, in one embodiment, the container can be gripped in its neck area and, in a manner similar to the so-called “neck handling” of PET bottles, transported to the next treatment station. In this way it is also possible to achieve transport of the applicable containers which is substantially free of sloshing and contamination.

The method for transporting containers filled with fluid which is described above can be carried out with PE containers with a filling volume of more than 1.5 liters (more than three liters in one embodiment), such as for filling volume of a half-gallon or a full gallon container.

Accordingly, the device for transporting containers filled with fluid, such as in a beverage filling plant, comprises a lowering device for lowering the fluid level in the container, and a conveying device for conveying the container with a lowered fluid level.

The provision of the lowering device for lowering the fluid level in the container makes it possible to achieve the transport of the container without the occurrence of excessive sloshing of the fluid contained in the container, or makes it possible to prevent completely such sloshing or overflow of the fluid.

By means of a raising device, the fluid level can be raised again after transport, or at the next treatment station, in order to enable an appropriate treatment of the container to be carried out. By the raising of the fluid level, for example, uniform fill levels in all closed containers can be achieved.

The lowering device and/or the raising device are preferably configured such that they act directly on the flexible base of each container.

### BRIEF DESCRIPTION OF FIGURES

Further embodiments and aspects of the present invention are more fully explained by the description below of the figures.

FIG. 1 is a schematic side elevation of a container on a device for transporting the container in a first embodiment;

FIG. 2 is a schematic detail view of a container which is changing direction during transport according to one embodiment;

FIG. 3 is a schematic plan view of the transfer area between a filler carrousel and a discharge starwheel in a beverage filling plant according to one embodiment;

FIG. 4 is a schematic plan view of a section of a beverage filling plant, comprising a filler carrousel and a capper according to one embodiment;

FIG. 5 is a schematic representation of a raising device for raising the fluid level in a container according to one embodiment; and

FIG. 6 is a schematic representation of a side elevation of a transporting device in a further example embodiment.

### DETAILED DESCRIPTION

Examples of embodiments are described below with the aid of the figures. In the figures, elements which are identical or similar, or have identical effects, are designated with identical reference signs, and repeated description of these elements is in part dispensed with in the description below, in order to avoid redundancy.

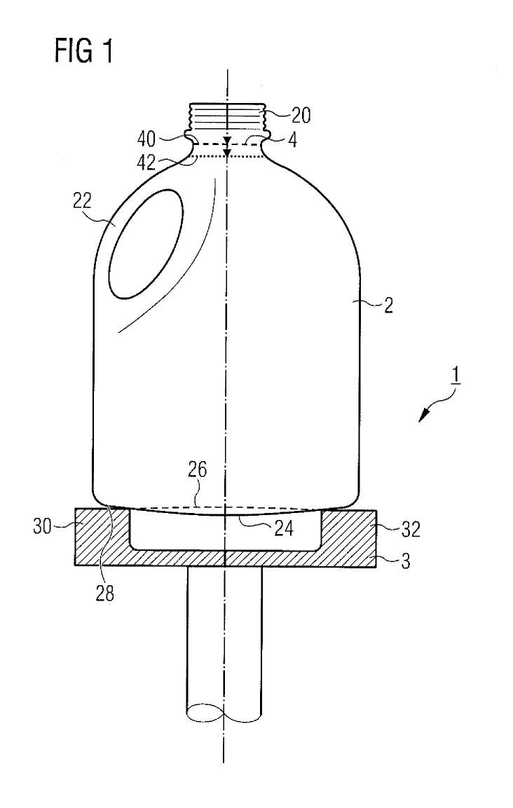

FIG. 1 shows schematically a transporting device 1 for transporting a container 2 filled with a fluid according to one embodiment. The container 2 is for example a container formed from a PE material with a filling volume of one gallon (approx. 3.7 liters), which has a mouth 20 of a relatively large diameter and a handle area 22. The material of container 2, such as a PE material in the example embodiment shown, has a thickness low enough to cause the container 2 to be relatively flexible. In particular, a base 24 of the container 2 is sufficiently flexible that it deviates downwards when not supported. In FIG. 1, the base 24 of the container 2 which has already deviated is shown, and its original flat contour is indicated schematically by a dashed line 26.

The transporting device 1 comprises a container support 3, upon which the container 2 is transported. The container 2 stands on the container support 3, and is transported on this through a section of the beverage filling plant. For example, the container support 3 is positioned below the filling valve in a filler carrousel.

The filling of container 2 with fluid through the mouth 20 causes the base 24 of the container 2 to bulge downwards. For this purpose, the container support 3 has a lowering device, which is formed in the example embodiment shown in FIG. 1 by providing two rails 30, 32 disposed parallel (although not required) to each other which support the container 2 only in an edge area 28 of the base 24. Accordingly, at least the central area of the base 24 of the container 2 is unsupported to an extent which allows the base 24 to deviate downwards from its flat contour 26.

The lowering device comprising the two rails 30, 32 accordingly causes a fluid level 4 in the container to be lowered from an initial level 40, when the base 24 is flat as indicated by the dashed line 26, to a lowered level 42, by means of the base 24 hanging down in the lowering device which comprises the two rails 30, 32.

By lowering the fluid level 4 from the initial level 40 to the lowered level 42, it is possible to achieve a significant reduction, as compared to the initial fluid level, in the tendency, during the transport of the container 2 on the transporting device 1, for fluid to slosh out of the mouth 20 and thereby contaminate both the mouth area and the remainder of the container 2.

The lowering device comprising the two rails 30, 32 can be already present, or put into operation, during the filling process in such a manner that the bulging of the base 24 of the container 2 takes place automatically during the process of filling with the fluid. Accordingly, the lowering of the fluid level from the initial level 40 to the lowered level 42 takes place continuously during the filling, although the actual lowering may only be detectable after the filling process is completed. This procedure is especially suitable in combination with a volume-controlled or weight-controlled filling process, in which a predetermined filling volume and predetermined filling weight of fluid, respectively, are to be achieved in the container 2 that is to be filled.

In an alternative example embodiment, which is not shown, the transport method and the device for transporting are also suitable for use in combination with a probe filler, which allows a predetermined fluid level to be achieved in the container 2. When a probe filler is used, it is, however, necessary for the lowering of the fluid level from the initial level 40 to the lowered level 42 to take place only after completion of the filling process, so that no incorrect measurements of the fill level are made.

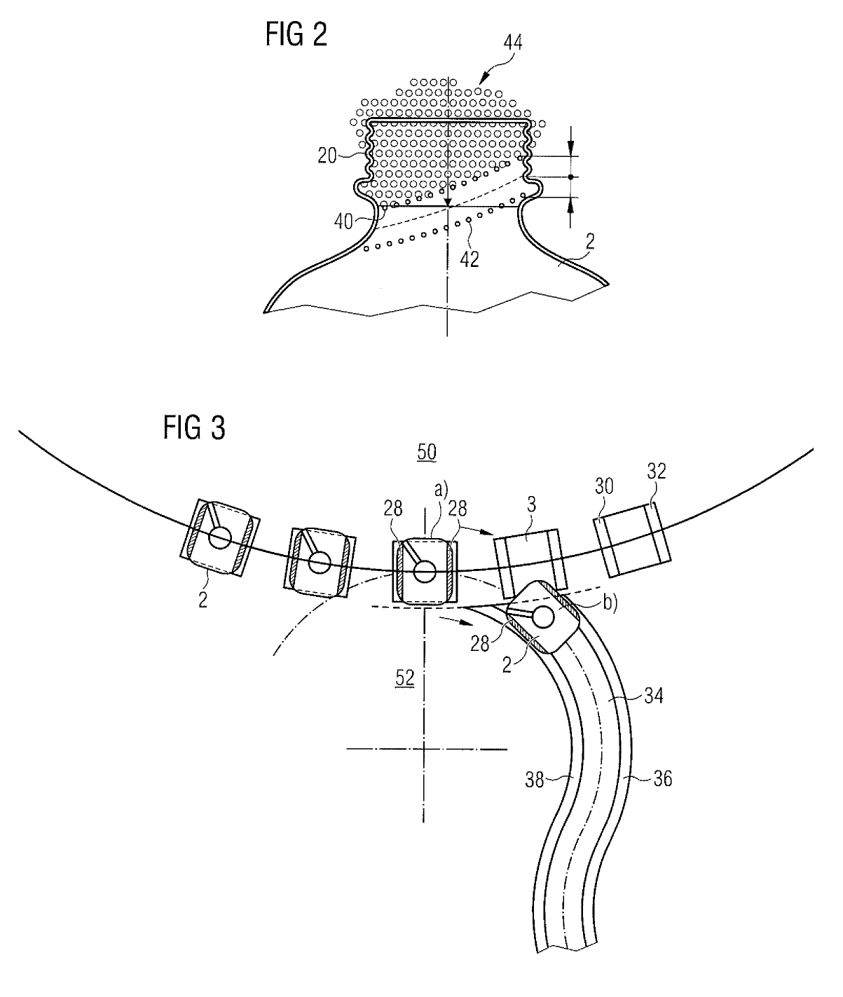

FIG. 2 shows a detailed view of the mouth area 20 of the container 2, with both the initial level 40 and the lowered level 42 indicated. The container 2 is shown in FIG. 2 in a condition in which it experiences lateral acceleration, for instance when the direction of transport changes or when it is conveyed in a circle, such as for example occurs in a rotary filler. The fluid contained in container 2 is thereby deflected due to the lateral acceleration, as can be seen in FIG. 2. Any sloshing over of the fluid in container 2, along with the foam 44 that is also indicated schematically, can thereby be reduced, or prevented completely, by lowering the fluid level from the initial level 40 to the lowered level 42. Correspondingly, any contamination of the outer area of the mouth 20 can also be substantially reduced or even prevented completely if the fluid level is lowered from the initial level 40 to the lowered level 42.

The lowering of the fluid level results in an increase in the volume of the container 2 due to the bulging of the base 24 of the container 2 in a downwards direction.

FIG. 3 shows a schematic plan view of a beverage filling plant, comprising a filler carrousel 50 which has a plurality of circulating container supports 3, each of which is provided, as shown schematically in a cutaway view in FIG. 1, with two rails 30, 32 disposed parallel to each other.

A discharge starwheel 52 is further provided, by means of which the containers 2 which are filled in the filler carrousel 50 are channeled out of the filler carrousel 50. Below the discharge starwheel 52, as a further container support, an appropriate transfer track 34 is provided, which has two rails 36, 38 disposed along its sides. The container 2 is conveyed on this transfer track 34, as shown as an example at position b), such that only its edge area 28 rests on the rails 36, 38. The result is that here too the base 24 of the container 2 hangs down, and the fluid level in container 2 is thereby lowered. In this manner, sloshing over is avoided also in the case of this change of direction of transport.

In position a), the accommodation of the container 2 on the container support 3 is again shown schematically such that the edge area 28, which rests on the rails 30, 32 disposed parallel to each other, can be clearly seen. Because only the edge area 28 of the container 2 rests on the rails 30, 32, and thus the base 24 is not supported across its entire surface, the lowering of the fluid level as shown in FIGS. 1 and 2 is achieved. This lowering of the fluid level is also maintained in the area of the discharge starwheel 52 by the two rails 36, 38 which run parallel to each other. Thus when the container 2 is actually pushed down from the container support 3 to the rails 36, 38 of the transfer track 34, the geometry is designed such that the hanging area of the base 24 of the container 2 can substantially retain its downward deformation, and correspondingly the fluid level can remain in its lowered state at the moment of change of direction.

The rails 36, 38 of the transfer track 34 are disposed at a distance from each other which is similar or identical to the distance between the two rails 30, 32 of the container support 3. When engaging the base of the container, however, they are rotated by approximately 180° in one embodiment.

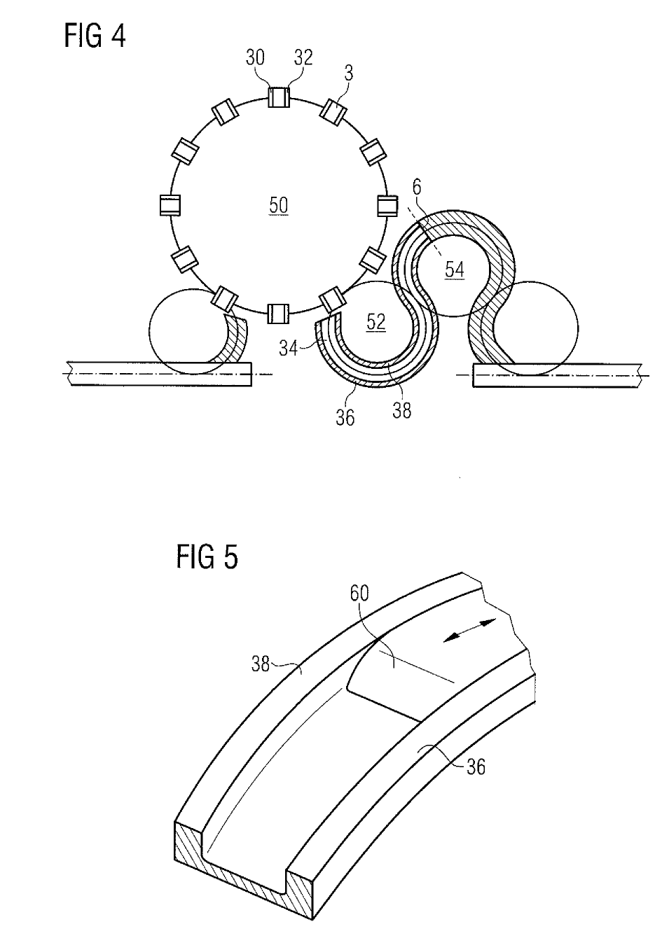

FIG. 4 shows another exemplary representation of a beverage filling plant, which is again provided with a filler carrousel 50, which serves to fill the containers with the appropriate fluid, and which comprises the container supports 3 already shown in, for example, FIGS. 1 and 3, with the rails 30, 32 disposed parallel to each other along their sides. A discharge starwheel 52 is also provided, which conveys the containers on a transfer track 34 on corresponding rails 36, 38 in such a manner that the fluid level is not raised again, but remains at a lowered level. A capper 54 adjoins the discharge starwheel 52. In the area of the capper, a transition area 6 is provided, which has a raising device 60 (shown in FIG. 5) to raise the fluid level.

The raising device 60 is shown in FIG. 5 by a moveable wedge, which raises the level of the central section between the two rails 36, 38 to form a uniform level over the entire surface. In other words, the base 24 of a container 2, which has bulged downwards as shown for example in FIG. 1, is conveyed via the two rails 36, 38 to the raising device 60, where the base is then lifted back so that it is flat across its entire surface, and the fluid level in the container is correspondingly raised back to its initial value.

By means of the raising of the fluid level, a higher fluid level within the container 2 can be achieved when the container is closed in the capper 54. Furthermore, the wedge can alternatively be configured to achieve a specified fill level in the mouth of the filled container. This can be achieved in that the base is selectively lifted—either for a particular batch of containers, or individually for each separate container. In this manner a constant fill level can be achieved independently of the particular design of each batch of containers.

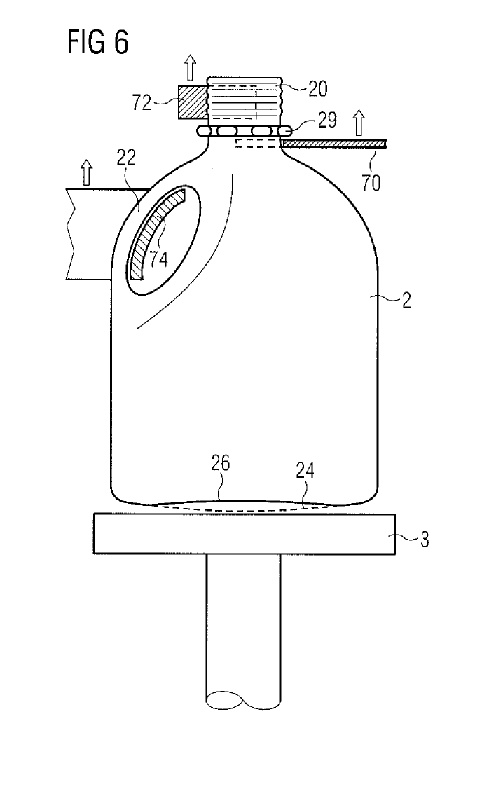

FIG. 6 shows a further embodiment of a lowering device, wherein the container 2 is again initially transported on a container support 3, which is here formed to be flat across its entire surface. In order to lower the fluid level, however, the container 2 is lifted, for example at a neck ring 29, in the mouth area 20, and/or in the handle area 22 via corresponding lifting devices 70, 72 or 74. The lifting device 70, which engages under the neck ring 20, the lifting device 72, which engages the thread in the mouth area 20 of the container 2, and/or the lifting device 74, which engages the handle area 22 of the container 2, can be provided either together or in any combination. What is essential is that the non-rigid container 2, for example a PE container with a content of for example one gallon, is lifted such that its base 24 is brought into the bulged shape shown with a dashed line in FIG. 6, in such a manner that the fill level or the fluid level in the mouth falls. Subsequent raising of the fluid level can be achieved by setting the container 2 back upon a flat container support 3.

To the extent applicable, all individual features described in the individual example embodiments can be combined with each other and/or exchanged, without departing from the field of the invention.

We claim:

1. A method for transporting containers filled with a fluid, comprising:
extending downward a portion of a flexible base of a container to lower a fluid level of the fluid in the container, and
transporting the container having the deformed flexible base with a lowered fluid level.

2. The method of claim 1, further comprising extending upward the portion of the flexible base of the container to raise the fluid level of the fluid within the container.

3. The method of claim 1, wherein the transporting comprises changing a direction of travel of the container from a first transporting device to a second transporting device.

4. The method of claim 1, further comprising:
raising the fluid level of the fluid in the container to a predetermined level; and
closing the container.

5. The method of claim 1, further comprising lowering the fluid level of the container before or during a filling of the container.

6. The method of claim 1, wherein the portion of the flexible base is deformed from a current configuration to lower or raise the fluid level of the fluid in the container.

7. The method of claim 1, wherein the portion is an interior portion of the flexible base.

8. The method of claim 7, wherein the flexible base is placed on a container support having an interior cavity configured to enable the interior portion of flexible base to extend downward when the container is filled with fluid.

9. The method of claim 7, wherein the extending comprises lifting the container from a container support.

10. The method of claim 1, wherein the container has a filling volume greater than 1.5 liters.

11. A system for transporting containers filled with fluid, comprising:
a container support, wherein the container support comprises rails on a periphery of the container support and an opening between the rails, wherein a bottom portion of the container extends into the opening when the container is filled with fluid to lower a fluid level of the container; and
a conveyer for moving the container with the lowered fluid level.

12. The system of claim 11, wherein the conveyer comprises:
rails on a periphery of the conveyer;
an opening between a first portion of the rails to receive the extended bottom portion of the container; and
an interior support between a second portion of the rails to prevent the bottom portion of the container to extend downward when the container is filled with fluid.

13. The system of claim 11, wherein the rails on the periphery of the container support are substantially parallel.

14. The system of claim 11, wherein the rails on the periphery of the container support are configured to support outer portions of a flexible base of the container.

15. The system of claim 12, wherein the interior support comprises a slanted portion extending from a bottom of the opening to a top surface of the rails.

16. The system of claim 15, wherein a top surface of the interior portion is approximately on a same plane as a top surface of the rails.

17. The system of claim 12, wherein the contained with fluid is moved onto the interior support of the conveyer to move the bottom portion of the container upward and raise the fluid level of the container.

18. The system of claim 11, wherein the conveyer has at least one curved portion that moves the container in an arc during at least one part of moving the container.

19. The system of claim 11, further comprising a filler carrousel having a plurality of container supports.

20. The system of claim 19, wherein the convey moves containers onto and out of the filler carrousel.
